(19) United States
(12) Patent Application Publication
(10) Pub. No.: US 2003/0085709 A1
(43) Pub. Date: May 8, 2003

(54) DIAGNOSING SPARK PLUGS MALFUNCTION IN A DUAL PLUG ENGINE

(75) Inventors: David Karl Bidner, Livonia, MI (US); Lynn Edward Davison, Saline, MI (US); William Najib Mansur, Sterling Heights, MI (US)

Correspondence Address: FORD GLOBAL TECHNOLOGIES, INC, SUITE 600 - PARKLANE TOWERS EAST, ONE PARKLANE BLVD., DEARBORN, MI, 48126, US

(73) Assignee: Ford Global Technologies, Inc., Dearborn, MI

(21) Appl. No.: 09/682,953

(22) Filed: Nov. 2, 2001

(51) Int. Cl. F02P 17/00

(52) U.S. Cl. 324/393

(57) ABSTRACT

A system and method are disclosed for detecting spark plug malfunction in an engine having more than one spark plug per cylinder.

### BACKGROUND OF THE INVENTION

1. Field of the Invention

The present invention relates generally to a method for determining spark plug malfunction.

2. Background of the Invention

To ensure engine emission performance, it is desirable to perform testing of the engine during operation. An engine equipped with two spark plugs per cylinder provides a unique opportunity to detect a spark plug failure. According to U.S. Pat. No. 5,872,312, one of the two spark plugs in each cylinder in a bank of the engine's cylinders is disabled. Stated another way, one half of the spark plugs in an entire bank are simultaneously disabled. If a misfire is detected during testing on the bank of cylinders, a spark plug of each cylinder is disabled in succession. In this way, it may be determined which spark plug is experiencing a malfunction.

The inventors have recognized a problem with the approach in U.S. Pat. No. 5,872,312 in that, if a spark plug is malfunctioning, two misfires occur in the process of identifying the malfunctioning cylinder, i.e., a first misfire occurs in the bank testing of cylinders and a second misfire in testing individual cylinders. Because a misfire may lead to hydrocarbon emission and may cause overheating of an exhaust catalyst, misfire occurrence should be minimized. The inventors of the present invention have recognized an alternative procedure to detect spark plug malfunction which overcomes the problem of multiple misfires.

### SUMMARY OF INVENTION

Disadvantages of prior art approaches are overcome by a method for controlling and diagnosing a multi-cylinder internal combustion engine having two spark plug in each cylinder to determine spark plug malfunction by disabling one of the spark plugs during a test period in a particular cylinder. It is determined whether a misfire has occurred during the disablement, which provides an indication of malfunction of the other spark plug. During the test period, each spark plug is disabled only once.

An advantage of the present invention is that if a spark plug malfunction is occurring, it can be detected in one misfire occurrence. In prior art, two misfires occur in performing the detection scheme. Because misfires lead to short bursts of higher exhaust emissions and a large increase in catalyst temperature, the present invention provides a clear advantage in lower hydrocarbon emission and a lower potential for overheating and possibly melting a catalyst.

An additional advantage is that the present invention requires fewer processes to be undertaken to determine which spark plug is malfunctioning. The algorithm may be performed in a shorter period of time, thereby providing a more rapid identification of a malfunctioning spark plug.

According to another aspect of the present invention, a method for controlling and diagnosing a multi-cylinder internal combustion engine is disclosed in which an ignition spark is provided through a first spark plug positioned in one of the cylinders near a center axis of the cylinder and ignition spark is provided through a second spark plug positioned in the cylinder near a wall of the cylinder. The first spark plug is disabled during a test period in one of the cylinders and it is determined whether a misfire has occurred during the period that the first spark plug is disabled. A misfire provides an indication of a malfunction of the second spark plug. An advantage of this aspect of the present invention in providing smoother engine operation during the diagnostic procedure than prior art methods in engines with one of the spark plugs located near a cylinder wall and one of the spark plugs centrally located. When prior art approaches are used to diagnose the spark plugs located near a wall in a dual bank engine, the centrally located plug along an entire bank of cylinders are disabled simultaneously. Even if none of the spark plugs being diagnosed were malfunctioning, simply by performing the diagnostic procedure torque drops about 15% during the disablement due to the loss of combustion initiation in the dominant position, the central position. Such a torque drop would be noticeable and objectionable to the driver. The situation is even worse if the prior art diagnostic routine were performed on an engine with a single bank of cylinders. The present invention, in contrast, provides for diagnosing one cylinder at a time resulting in a torque loss of about 5% (in a 6-cylinder engine), which is well within the range of normal cycle-to-cycle torque differences.

The above advantages, other advantages, and other features of the present invention will be readily apparent from the following detailed description of the preferred embodiments when taken in connection with the accompanying drawings.

### BRIEF DESCRIPTION OF DRAWINGS

The advantages described herein will be more fully understood by reading an example of an embodiment in which the invention is used to advantage, referred to herein as the Detailed Description, with reference to the drawings wherein:

FIG. 1 is a schematic of a V-6 engine with two spark plugs per cylinder;

FIG. 2 is a cross-sectional representation of the valves and spark plugs as they may be arranged in a single cylinder of the engine;

FIG. 3 is a cross-sectional representation of the valves and spark plugs as they may be arranged in a single cylinder of the engine; and

FIG. 4 is a flowchart indicating steps by which the present invention may be used to advantage.

### DETAILED DESCRIPTION

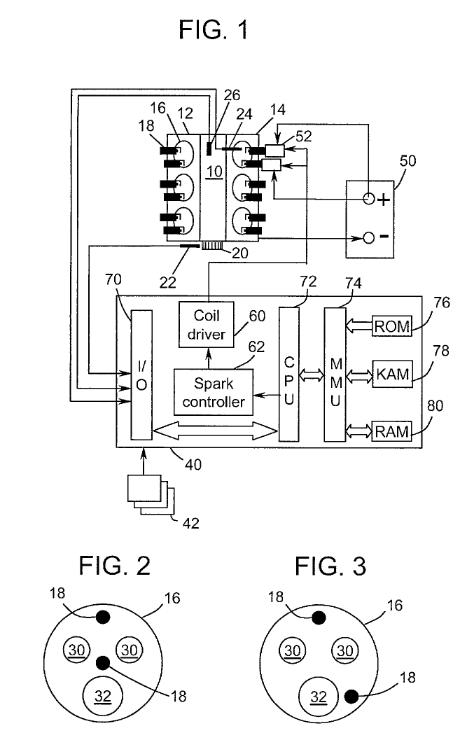

In FIG. 1 a six-cylinder engine 10 is shown. Engine 10 contains two banks, 12 and 14, of cylinders with three cylinders in each bank. The present invention applies to any number of engine banks with any number of cylinders per bank. Each cylinder 16 contains two spark plugs 18. However, the present invention also applies to more than two spark plugs per cylinder. Spark plugs 18 may be arranged in various configurations in the cylinder and will be discussed more fully below in regards to FIGS. 2 and 3. Spark plugs 18 are connected to ignition coils 52, shown for one cylinder only in FIG. 1. The configuration shown in FIG. 1 is commonly called coil on plug. The present invention also applies to other coil configurations. Ignition coils 52 are connected to battery 50, which supplies battery voltage to the low voltage side of ignition coil 52. Ignition coil 52 transforms low voltage to high voltage, which is provided to spark plugs 18. Ignition coils 52 are controlled or switched by coil driver 60, which is shown on board electronic control unit 40 (ECU) in FIG. 1. However, coil driver 60 may be mounted elsewhere and provide the same function. A signal is supplied by spark controller 62 to cause coil driver 60 to switch, thereby causing spark firing.

Various devices may be used to assess whether combustion occurs in response to a request for spark plug firing. Engine 1 0 has a toothed disk 20 coupled to the crankshaft (not shown) of engine 10. Sensor 22 provides an output as the teeth of toothed disk 20 pass by sensor 22. Engine speed can be computed based on the signal from teeth passing sensor 22. Engine speed drops momentarily when a cylinder experiences a misfire, i.e., combustion failure. Alternatively, a misfire is detected by an engine sensor 24 as shown in FIG. 1, by way of example, in one cylinder of engine 10. However, each cylinder 16 of engine 10 preferably would contain engine sensor 24. Engine sensor 24 may be a luminosity detector which senses the light in the cylinder entering the detector. As combustion emits visible light, detection of light can be used to indicate whether combustion has been initiated. Alternatively, engine sensor 24 may be a pressure sensor. Cylinder pressure increases due to a combustion event; thus, pressure may also be used to determine whether combustion has been initiated. Engine block sensor 26 may be a strain gauge attached to the surface of the engine block, the output of which is affected by the pressure developed in cylinders 16. In FIG. 1, only one engine block sensor 26 is shown. It may be found that multiple engine block sensors 26 are needed to accurately determine whether a combustion event has occurred.

A piston (not shown) is disposed and reciprocates within each cylinder 16 of engine 10. In four-stroke operation, the processes are: an intake stroke during which the piston moves down or away from the cylinder head (not shown) in which the spark plugs 18 are typically disposed, a compression stroke as the piston moves up, an expansion or power stroke as the piston moves down, and an exhaust stroke as the piston moves up. Combustion typically is initiated toward the end of the compression stroke with the majority of combustion occurring during the expansion stroke. If spark plugs 18 fail to ignite the fuel and air mixture in a particular cylinder, the mixture does not combust and the expansion stroke provides much less power to the engine's crankshaft than if a combustion event had occurred. The rotational speed of engine 10 dips slightly when combustion in one of the cylinders fails to occur. The drop in speed, however, is momentary and occur only during part of a revolution of engine 10 because the next cylinder to undergo an expansion stroke produces power causing engine 10 to reattain the speed prior to misfire. Other known methods of detecting engine misfire which may be used to advantage include: detecting an anomalous signal from an gas sensor (not shown) positioned in the engine exhaust which measures exhaust air/fuel ratio and detecting changes in alternator (not shown).

ECU 40 is provided to control engine 10, in general, and spark plugs 18, as shown specifically in FIG. 1. ECU 40 has a microprocessor 72, called a central processing unit (CPU), in communication with memory management unit (MMU) 74. MMU 74 controls the movement of data among the various computer readable storage media and communicates data to and from CPU 72. The computer readable storage media preferably include volatile and nonvolatile storage in read-only memory (ROM) 76, random-access memory (RAM) 80, and keep-alive memory (KAM) 78, for example. KAM 78 may be used to store various operating variables while CPU 72 is powered down. The computer-readable storage media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by CPU 72 in controlling the engine or vehicle into which the engine is mounted. The computer-readable storage media may also include floppy disks, CD-ROMs, hard disks, and the like. CPU 72 communicates with various sensors and actuators via an input/output (I/O) interface 70. Examples of items that are actuated under control by CPU 72, through I/O interface 70, are fuel injection timing, fuel injection rate, fuel injection duration, throttle valve position, spark plug timing, and others. Sensors 42 communicating input through I/O interface 70 may be indicating engine rotational speed 22, vehicle speed, coolant temperature, manifold pressure, pedal position, throttle valve position, air temperature, exhaust temperature, and air flow 50. Spark plug timing is determined in CPU 62 and communicated to spark controller 62. This configuration of spark controller 62 comprising a separate chip in FIG. 1 is shown by way of example. Alternatively, the functionality of spark controller 62 could be contained in CPU 72. Some ECU 40 architectures do not contain MMU 74. If no MMU 74 is employed, CPU 72 manages data and connects directly to ROM 76, RAM 80, and KAM 78. Of course, the present invention could utilize more than one CPU 72 to provide engine control and ECU 40 may contain multiple ROM 76, RAM 80, and KAM 78 coupled to MMU 74 or CPU 74 depending upon the particular application.

In FIG. 2, an example of a two spark plug 18 arrangement is shown for one cylinder in which one spark plug 18 is centrally located and one spark plug 18 is located near the periphery of the cylinder 16, near the cylinder 16 wall. In this case, the central plug may be considered a primary plug and the peripheral plug a secondary plug. The primary initiates the primary combustion event; and the secondary plug assists with later combustion or may provide additional certainty of combustion under marginal circumstances, such as cold start, high dilution of the combustion gases with burned gases, or lean burn. Also shown in FIG. 2, by way of example, are two exhaust valves 30 and an intake valve 32. Another alternative is shown in FIG. 3, in which both spark plugs 18 are located near a cylinder 16 wall. In this case, both plugs provide substantially similar combustion waves, i.e., neither is considered a dominant plug. Regardless of spark plug 16 configuration and their relative importance in initiating combustion, the present invention may be applied to any multiple plug configuration. Also, the exhaust valves 30 and intake valve 32 configuration shown in FIGS. 2 and 3 is merely illustrative and the present invention applies to any arrangement, combination, and number of intake and exhaust valves.

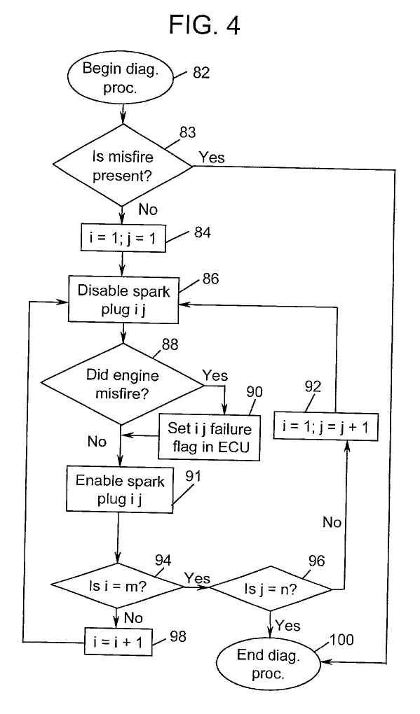

Referring now to FIG. 4, a diagnostic procedure for detecting a spark plug malfunction begins in step 82. The diagnostic procedure of the present invention depends on there not being a misfire, possibly due to a cause other than a spark plug malfunction such as low compression in a cylinder or a fuel injector problem. Thus, before getting to the heart of the detection scheme in which various spark plugs are temporarily disabled, it is determined if there is a misfire occurring in step 83. If there is a misfire occurring (positive result in step 83), the diagnostic procedure is discontinued by proceeding directly to step 100. If there is no misfire, i.e., a negative result in step 83, control passes to step 84, in which counters i and j are initialized to 1. Counter i is the cylinder number on the bank and j is the number of the bank. Control passes to step 86 in which one of the ij spark plugs are disabled. The testing may commence on the primary spark plug of each cylinder of the secondary spark plug in each cylinder. Alternately, these could be termed first and second spark plugs. If the primary spark plug is the subject of the diagnostic procedure, the secondary spark plug is the one that is disabled. The discussion below assumes the diagnostic procedure is being performed on the primary spark plug in each cylinder In step 88 it is determined if the engine experienced a misfire during the time of disablement of the secondary spark plug in the ij cylinder. If a positive result in step 88, control passes to step 90 in which a flag is set in ECU 40 indicating that the primary spark plug in the ij cylinder misfired. Control then passes to step 91; similarly control passes to step 91 if a negative result is returned in step 88. Regardless, in step 91 the secondary spark plug in the ij cylinder is enabled. Control then passes to step 94 where it is determined whether i=m. In the example of the V-6 engine, the number of cylinders per bank is 3; thus, m is 3, and the number of banks is 2; thus, n is 2. The diagnostic procedure is set up to assess all of the cylinders by counting i=1 through 3 and j=1 through 2, through all combinations. If a negative result is returned in step 94, control passes to step 98 where counter i is incremented and control passes back to step 86 where the secondary spark plug in the new ij cylinder is disabled for assessment of the primary plug. If a positive result is returned in step 94, this indicates that all of the cylinders on the jth bank have been assessed and control passes to step 96 in which it is determined whether j is equal to n. If a positive result is returned in step 96, the diagnostic procedure is terminated in step 100. If a negative result is returned in step 96, counter i is reset and counter j is incremented in step 92. Control then passes to step 86 where the new ij cylinder is assessed. Alternatively, the flowchart in FIG. 2 could be configured such that counter i counts through all the cylinders without regard for banks. Consequently, all references to j and n would be removed; step 94 would proceed directly to step 100; and, steps 92 and 96 would be removed. In this case, m would be equal to the total number of cylinders, eg., 6 for engine 10 of FIG. 1.

The procedure described in conjunction with FIG. 4 may be used for a first spark plug in each cylinder and repeated to assess a second spark plug in each cylinder. The present invention may be extended to a cylinder with more than two spark plugs. To assess a malfunction of a particular spark plug in such a configuration, all other spark plugs in that cylinder are disabled briefly to determine if the particular spark plug is malfunctioning.

The method for detecting a malfunction of a spark plug in a multiple plug described herein produces a momentary misfire of a cylinder, if a malfunctioning plug exists, an unlikely event. If this unlikely event does occur, no substantial functional disturbance to the engine performance results. Although this causes a slight drop in engine speed, if measured on the time scale of a part of a revolution, it is unnoticeable to the average operator. Instead, a savvy operator may notice the misfire only by aural cues, not by a noticeable drop in engine speed. The misfire causes a discharge of unburned fuel and air from the engine 10, which reacts in a catalytic converter, if engine 10 is so equipped. Oxidation of fuel in the catalytic converter leads to a large temperature rise in the catalytic converter and may harm the catalytic converter, particularly if several misfire events occur in rapid succession. Thus, although a single misfire event may be tolerated by the engine system, multiple misfire events should be avoided.

While several modes for carrying out the invention have been described in detail, those familiar with the art to which this invention relates will recognize alternative designs and embodiments for practicing the invention. The above-described embodiments are intended to be illustrative of the invention, which may be modified within the scope of the following claims.

1. A method for controlling and diagnosing a multi-cylinder internal combustion engine having a first and a second spark plug disposed in each cylinder to determine spark plug malfunction, comprising the steps of:
disabling the second spark plug during a predetermined test period in a predetermined cylinder wherein the second spark plug is disabled only once during said predetermined test period; and
detecting whether a misfire has occurred during said disablement of the second spark plug, said misfire providing an indication of malfunction of the first spark plug.

2. The method of claim 1 wherein said malfunction is based on a decrease in the engine's rotational speed in response to said disablement of said first spark plug.

3. The method of claim 1 wherein said malfunction is based on an output of an engine rotational speed sensor located proximately to a toothed disk coupled to the engine.

4. The method of claim 2 wherein said malfunction is detected when engine speed decreases more than a predetermined amount during a single engine revolution in which said predetermined cylinder undergoes an expansion stroke.

5. The method of claim 1 further comprising the steps of enabling said first spark plug in response to said detection step.

6. The method of claim 1 further comprising the step of performing said disabling and detection steps on successive cylinders.

7. The method of claim 1 further comprising the step of storing in memory an identification of said predetermined cylinder in the event that a malfunction is detected.

8. A method for controlling and diagnosing a multi-cylinder internal combustion engine, the engine having a first spark plug positioned in one of the cylinders near a center axis of the cylinder and a second spark plug positioned in the cylinder near a wall of the cylinder, comprising the steps of:
providing ignition spark through said first spark plug;
providing ignition spark through said second spark plug;
disabling said first spark plug in the cylinder; and
detecting whether a misfire of said second spark plug has occurred during said disablement of said first spark plug, said misfire providing an indication of malfunction of said second spark plug.

9. The method of claim 8 wherein said malfunction is based on an output of an engine rotational speed sensor located proximately to a toothed disk coupled to the engine.

10. The method of claim 9 wherein said malfunction is detected when engine rotational acceleration decreases more than a predetermined amount during a single engine revolution in which said predetermined cylinder undergoes an expansion stroke.

11. A method for controlling and diagnosing a multi-cylinder internal combustion engine, comprising the steps of:
providing a first ignition spark in one of the cylinders near a center axis of said cylinder;
providing a second ignition spark in said cylinder near a wall of the cylinder;
disabling said second ignition spark in said cylinder only once during a predetermined test period; and
detecting whether a misfire has occurred during said disablement of said second ignition spark, said misfire providing an indication of malfunction of said first ignition spark.

2. The method of claim 11 further comprising the steps of enabling said second ignition spark in response to said detection step.

13. The method of claim 11 further comprising the step of performing said disabling and detection steps on successive cylinders.

14. The method of claim 11 further comprising the step of storing in memory an identification of said one of the cylinders in the event that a misfire is detected.

15. A method for diagnosing a spark plug malfunction in a multi-cylinder internal combustion engine having at least two spark plugs disposed in each cylinder, consisting essentially of the steps of:
disabling all spark plugs other than a predetermined spark plug in a predetermined cylinder; and
detecting whether a misfire has occurred during said disablement of said other spark plugs, said misfire providing an indication of malfunction of said predetermined spark plug.

16. The method of claim 15 wherein said malfunction is based on output of an engine rotational speed sensor located proximately to a toothed disk coupled to the engine.

17. The method of claim 1 S wherein said malfunction is based on output of a luminosity detector coupled to said predetermined cylinder.

18. The method of claim 1 5 wherein said malfunction is based on output of a pressure sensor coupled to said predetermined cylinder.

19. The method of claim 1 5 wherein said malfunction is based on output of a strain gauge coupled to the engine.

20. A system for diagnosing a spark plug malfunction in a multi-cylinder engine comprising:
a spark plug disposed in one of the cylinders near a center axis of said cylinder;
a spark plug disposed in said cylinder near a w all of said cylinder;
a means for detecting a misfire in said cylinder; and
an electronic control unit operably connected to said spark plugs and to said detection means, said control unit disables one of said spark plugs in said cylinder of the engine and determines whether said misfire has occurred when said spark plug is disabled.

21. The system of claim 20 wherein said detection means is a rotational speed sensor located proximately to a disk coupled to the engine.

22. The system of claim 21, said disk contains teeth on said disk's periphery.

23. The system of claim 21, said disk is rigidly connected to the crankshaft of the engine so that rotation of said disk is substantially coincident with rotation of said crankshaft.

24. The system of claim 20 wherein said detection means is a luminosity sensor positioned so that said luminosity sensor may detect visible light within said cylinder.

25. The system of claim 20 wherein said detection means is a pressure transducer disposed in said cylinder.

26. A computer readable storage medium having stored data representing instructions executable by a computer to diagnose and detect spark plug malfunction in a multi-cylinder engine having at least two spark plugs disposed in each cylinder comprising:
a memory location containing a spark plug identification counter;
a memory location containing a cylinder identification counter;
instructions initiating the diagnosis of a particular spark plug in each cylinder, said particular spark is identified by said spark plug counter;
instructions disabling a set of spark plugs, said set of spark plugs comprises all spark plugs in a cylinder identified by said cylinder identification counter except said particular spark plug and said set of spark plugs is disabled only once during said diagnosis of said particular spark plug; and
instructions providing an indication that said particular spark plug in said cylinder identified by said cylinder identification counter has malfunctioned during said disablement of said set of spark plugs.

27. A computer readable storage medium of claim 26, further comprising instructions resetting said cylinder identification counter in response to said initiation instructions.

28. A computer readable storage medium of claim 27, further comprising instructions storing said cylinder identification counter and said spark plug identification counter in a memory location in the event of an indication of malfunction of said particular spark plug.

29. A computer readable storage medium of claim 28, further comprising instructions re-enabling said set of spark plugs in response to said disabling instructions.

30. A computer readable storage medium of claim 29, further comprising:
instructions incrementing a cylinder identification counter in response to said reenabling step;
instructions repeating said disabling instructions, said providing instructions, and said re-enabling instructions when said cylinder identification counter is less than or equal to the number of cylinders of the engine; and
instructions completing said diagnosis of said particular spark plug in each cylinder when said cylinder identification counter is greater than said number of cylinders of the engine.

31. A computer readable storage medium of claim 30, further comprising:
instructions incrementing said spark plug identification counter;
instructions repeating said initiating instructions, said resetting of said cylinder identification counter instructions, said disabling instructions, said providing instructions, said storing instructions, and said re-enabling instructions, when said spark plug counter is less than or equal to the number of spark plugs in each cylinder; and
instructions terminating the diagnosis and determination of spark plug malfunction when said spark plug identification counter is greater than the number of spark plugs in each cylinder.

32. A computer readable storage medium of claim 31 further comprising instructions to reset said spark plug identification counter and said cylinder identification counter in response to said termination instructions.

33. A computer readable storage medium of claim 26, said indication of said malfunction is based on a decrease in engine speed when said set of spark plugs is disabled.
